(19) United States
(12) Patent Application Publication
(10) Pub. No.: US 2008/0242271 A1
(43) Pub. Date: Oct. 2, 2008

(54) ELECTRONIC DEVICE WITH LOCATION-BASED AND PRESENCE-BASED USER PREFERENCES AND METHOD OF CONTROLLING SAME

(76) Inventors: Kurt Schmidt, Chapel Hill, NC (US); William O. Camp, Chapel Hill, NC (US); Scott Clagett, Wake Forest, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/690,881

(22) Filed: Mar. 26, 2007

(51) Int. Cl. H04M 3/42

(52) U.S. Cl. 455/414.1

(57) ABSTRACT

A method of controlling preferences of a mobile telephone includes associating one or more user-settable preferences with a location or geographic area. The one or more preferences is applied to operation of the mobile telephone when the mobile telephone is at the location or geographic area. In one embodiment, the method includes associating one or more user-settable preferences with an electronic device having a known identity; detecting presence of the electronic device; and applying the one or more preferences associated with the electronic device to operation of the mobile telephone. In another embodiment, the method includes associating one or more user-settable preferences with a segment of time; and during the segment of time, applying the one or more preferences associated with the segment of time to operation of the mobile telephone.

### TECHNICAL FIELD OF THE INVENTION

The present invention relates generally to portable electronic devices and, more particularly, to an electronic device that has user preferences that change as the location of the electronic device changes and/or as other electronic devices enter or leave the vicinity of the electronic device.

### DESCRIPTION OF THE RELATED ART

Mobile and/or wireless electronic devices are becoming increasingly popular. For example, mobile telephones, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces.

The interface features of an electronic device may be a driving factor in a consumer's decision to purchase the electronic device over other electronic devices having similar functionality. Thus, product differentiation is sometimes viewed as desirable by distributors and retailers of consumer electronics. Also, many users perceive the ability to personalize an electronic device as being a high priority feature when making a purchasing decision.

### SUMMARY

To increase product differentiation among electronic devices and to increase the ability to personalize electronic devices, there is a need in the art for a device that changes user preferences based on various criteria. The changes may be driven by the location of the electronic device and/or the proximity of other electronic devices to the electronic device. Further, these location-sensitive and/or presence-sensitive attributes may be based on user settings.

According to one aspect of the invention, a method of controlling preferences of a mobile telephone includes associating one or more user-settable preferences with a location or geographic area; and applying the one or more preferences to operation of the mobile telephone when the mobile telephone is at the location or geographic area.

According to an embodiment of the method, the user-settable preference relates to a ringtone such that if a call is received when the mobile telephone is present at the location or geographic area, the mobile telephone will audibly output the ringtone.

According to an embodiment of the method, the user-settable preference relates to a message notification tone such that if a message is received when the mobile telephone is present at the location or geographic area, the mobile telephone will audibly output the message notification tone.

According to an embodiment of the method, the user-settable preference relates to a wallpaper such that when the mobile telephone is present at the location or geographic area, the mobile telephone will display the wallpaper in association with a graphical user interface.

According to an embodiment of the method, the user-settable preference relates to a configuration of a graphical user interface such that when the mobile telephone is present at the location or geographic area, the mobile telephone will display the configuration of the graphical user interface and function in accordance therewith.

According to an embodiment of the method, the user-settable preference relates to at least one of acceptable audiovisual content, acceptable ringtones, acceptable message notification tones or acceptable ringback tones, such that when the mobile telephone is present at the location or geographic area, the mobile telephone will filter at least one of audiovisual content, ringtones, message notification tones or ringback tones for acceptability before playback.

According to an embodiment, the method further includes associating one or more user-settable preferences with an electronic device having a known identity; detecting presence of the electronic device; and applying the one or more preferences associated with the electronic device to operation of the mobile telephone.

According to an embodiment, the method further includes associating one or more user-settable preferences with a segment of time; and during the segment of time, applying the one or more preferences associated with the segment of time to operation of the mobile telephone.

According to an embodiment, the method further includes associating one or more user-settable preferences with a velocity threshold; determining a velocity of the mobile telephone; and applying the one or more preferences associated with the velocity threshold when the velocity threshold is exceeded.

According to another aspect of the invention, a method of controlling preferences of a mobile telephone includes associating one or more user-settable preferences with an electronic device having a known identity; detecting presence of the electronic device; and applying the one or more preferences associated with the electronic device to operation of the mobile telephone.

According to an embodiment of the method, the user-settable preference relates to a ringtone such that if a call is received when presence of the electronic device is detected, the mobile telephone will audibly output the ringtone.

According to an embodiment of the method, the user-settable preference relates to a message notification tone such that if a message is received when presence of the electronic device is detected, the mobile telephone will audibly output the message notification tone.

According to an embodiment of the method, the user-settable preference relates to a wallpaper such that when presence of the electronic device is detected, the mobile telephone will display the wallpaper in association with a graphical user interface.

According to an embodiment of the method, the user-settable preference relates to a configuration of a graphical user interface such that when presence of the electronic device is detected, the mobile telephone will display the configuration of the graphical user interface and function in accordance therewith.

According to an embodiment of the method, the user-settable preference relates to at least one of acceptable audiovisual content, acceptable ringtones, acceptable message notification tones or acceptable ringback tones, such that when presence of the electronic device is detected, the mobile telephone will filter at least one of audiovisual content, ringtones, message notification tones or ringback tones for acceptability before playback.

According to an embodiment, the method further includes associating one or more user-settable preferences with a segment of time; and during the segment of time, applying the one or more preferences associated with the segment of time to operation of the mobile telephone.

According to an embodiment, the method further includes associating one or more user-settable preferences with a velocity threshold; determining a velocity of the mobile telephone; and applying the one or more preferences associated with the velocity threshold when the velocity threshold is exceeded.

According to another aspect of the invention, a method of controlling preferences of a mobile telephone includes associating one or more user-settable preferences with a segment of time; and during the segment of time, applying the one or more preferences associated with the segment of time to operation of the mobile telephone.

According to an embodiment of the method, the user-settable preference relates to a preference selected from a ringtone, a message notification tone, a wallpaper, a configuration of a graphical user interface and combinations thereof.

According to an embodiment of the method, the user-settable preference relates to at least one of acceptable audiovisual content, acceptable ringtones, acceptable message notification tones or acceptable ringback tones, such that during the segment of time, the mobile telephone will filter at least one of audiovisual content, ringtones, message notification tones or ringback tones for acceptability before playback.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of one embodiment of a mobile telephone as an exemplary electronic device in accordance with the present invention;

FIG. 2 is a schematic block diagram of the relevant portions of the mobile telephone of FIG. 1;

FIG. 3 is a schematic diagram of a communications system in which the mobile telephone of FIG. 1 may operate; and

FIG. 4 is a flow chart representing an exemplary method of controlling user preferences of an electronic device.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smartphones, portable communication apparatus or the like.

In the present application, embodiments of the invention are described primarily in the context of a mobile telephone. However, it will be appreciated that the invention is not intended to be limited to the context of a mobile telephone and may relate to any type of appropriate electronic equipment, examples of which include a media player, a gaming device and a computer.

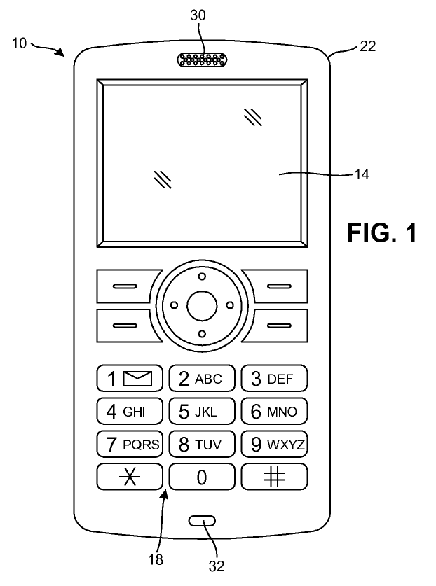

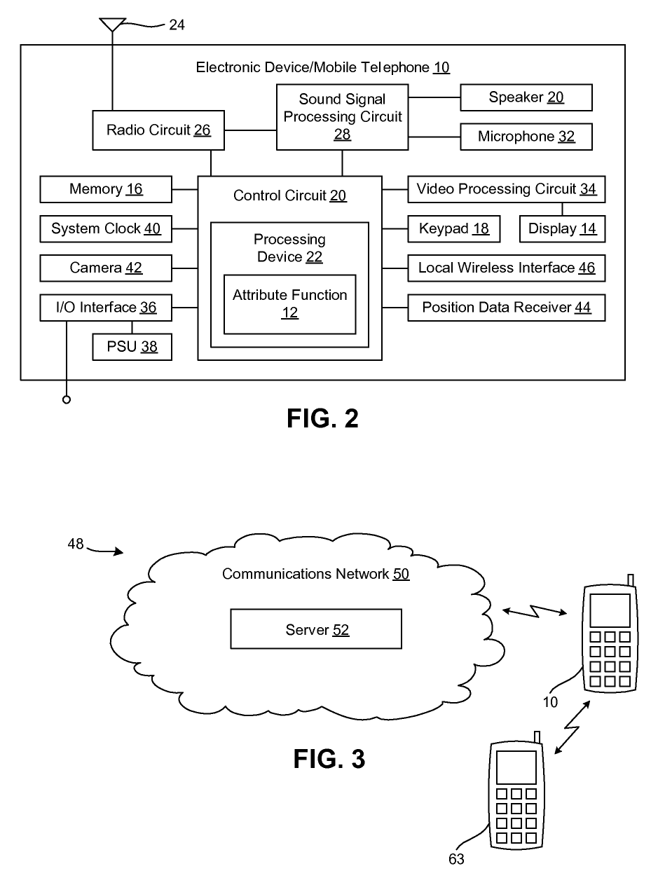

Referring initially to FIGS. 1 and 2, an exemplary electronic device 10 is shown. The electronic device 10 is configured to change user preferences depending on the location of the electronic device 10 and/or depending on the presence of other electronic devices. The user may configure the conditions that trigger a change in the preferences. Exemplary preferences that may be changed are described in greater detail below. The various preferences may be grouped into profiles for use in certain situations as will be described in greater detail below.

The electronic device 10 may include an attribute function 12 that is configured to control the changeable preferences of the electronic device 10. Additional details and operation of the changeable preferences and the attribute function 12 will be described in greater detail below. The attribute function 12 may be embodied as executable code that is resident in and executed by the electronic device 10. In one embodiment, the attribute function 12 may be a program stored on a computer or machine readable medium. The attribute function 12 may be a stand-alone software application or form a part of a software application that carries out additional tasks related to the electronic device 10.

The electronic device of the illustrated embodiment is a mobile telephone and will be referred to as the mobile telephone 10. The mobile telephone 10 is shown as having a “brick” or “block” form factor housing, but it will be appreciated that other housing types may be utilized, such as a “flip-open” form factor (e.g., a “clamshell” housing) or a slide-type form factor (e.g., a “slider” housing).

The mobile telephone 10 may include a display 14. The display 14 displays information to a user such as operating state, time, telephone numbers, contact information, various navigational menus, etc., through a graphical user interface (GUI) that enables the user to utilize the various features of the mobile telephone 10. The display 14 also may be used to visually display content received by the mobile telephone 10 and/or retrieved from a memory 16 (FIG. 2) of the mobile telephone 10. The display 14 may be used to present images, video and other graphics to the user, such as photographs, mobile television content and video associated with games.

A keypad 18 provides for a variety of user input operations. For example, the keypad 18 typically includes alphanumeric keys for allowing entry of alphanumeric information such as telephone numbers, phone lists, contact information, notes, etc. In addition, the keypad 18 typically includes special function keys such as a “call send” key for initiating or answering a call, and a “call end” key for ending or “hanging up” a call. Special function keys also may include menu navigation and select keys to facilitate navigating through a menu displayed on the display 14. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 18 may be used in conjunction with one another to implement soft key functionality.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 10 may be configured to transmit, receive and/or process data, such as text messages (e.g., a text message is commonly referred to by some as “an SMS,” which stands for simple message service), instant messages, electronic mail messages, multimedia messages (e.g., a multimedia message is commonly referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth.

FIG. 2 represents a functional block diagram of the mobile telephone 10. For the sake of brevity, generally conventional features of the mobile telephone 10 will not be described in great detail herein. The mobile telephone 10 includes a primary control circuit 20 that is configured to carry out overall control of the functions and operations of the mobile telephone 10. The control circuit 20 may include a processing device 22, such as a CPU, microcontroller or microprocessor. The processing device 22 executes code stored in a memory (not shown) within the control circuit 20 and/or in a separate memory, such as the memory 16, in order to carry out operation of the mobile telephone 10. The memory 16 may be, for example, one or more of a buffer, a flash memory, a hard drive, a removable media, a volatile memory, a non-volatile memory, a random access memory (RAM), or other suitable device.

In addition, the processing device 22 may execute code that implements the attribute function 12. It will be apparent to a person having ordinary skill in the art of computer programming, and specifically in application programming for mobile telephones or other electronic devices, how to program a mobile telephone 10 to operate and carry out logical functions associated with the attribute function 12. Accordingly, details as to specific programming code have been left out for the sake of brevity. Also, while the attribute function 12 is executed by the processing device 22 in accordance with a preferred embodiment of the invention, such functionality could also be carried out via dedicated hardware, firmware, software, or combinations thereof, without departing from the scope of the invention.

Continuing to refer to FIGS. 1 and 2, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10 as is conventional. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream that is received by the radio circuit 28 or obtained by any other suitable method.

The mobile telephone 10 may further include one or more I/O interface(s) 36. The I/O interface(s) 36 may be in the form of typical mobile telephone I/O interfaces and may include one or more electrical connectors. As is typical, the I/O interface(s) 36 may be used to couple the mobile telephone 10 to a battery charger to charge a battery of a power supply unit (PSU) 38 within the mobile telephone 10. In addition, or in the alternative, the I/O interface(s) 36 may serve to connect the mobile telephone 10 to a headset assembly (e.g., a personal handsfree (PHF) device) that has a wired interface with the mobile telephone 10. Further, the I/O interface(s) 36 may serve to connect the mobile telephone 10 to a personal computer or other device via a data cable for the exchange of data. The mobile telephone 10 may receive operating power via the I/O interface(s) 36 when connected to a vehicle power adapter or an electricity outlet power adapter.

The mobile telephone 10 also may include a system clock 40 for clocking the various components of the mobile telephone 10, such as the control circuit 20. The control circuit 20 may, in turn, carry out timing functions, such as timing the durations of calls, generating the content of time and date stamps, and so forth.

The mobile telephone 10 may include a camera 42 for taking digital pictures and/or movies. Image and/or video files corresponding to the pictures and/or movies may be stored in the memory 16.

The mobile telephone 10 also may include a position data receiver 44, such as a global positioning system (GPS) receiver, Galileo satellite system receiver or the like. The position data receiver 44 may be involved in ascertaining the location of the mobile telephone 10. The determination of the location of the mobile telephone 10 will be described in greater detail below.

The mobile telephone 10 also may include a local wireless interface 46, such as an infrared transceiver and/or an RF interface (e.g., a Bluetooth interface), for establishing communication with an accessory, another mobile radio terminal, a computer or another device. For example, the local wireless interface 46 may operatively couple the mobile telephone 10 to a headset assembly (e.g., a PHF device) in an embodiment where the headset assembly has a corresponding wireless interface.

With additional reference to FIG. 3, the mobile telephone 10 may be configured to operate as part of a communications system 48. The system 48 may include a communications network 50 having a server 52 (or servers) for managing calls placed by and destined to the mobile telephone 10, transmitting data to the mobile telephone 10 and carrying out any other support functions. The server 52 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 50 may support the communications activity of multiple mobile telephones 10 and other types of end user devices. As will be appreciated, the server 52 may be configured as a typical computer system used to carry out server functions and may include a processor configured to execute software containing logical instructions that embody the functions of the server 52 and a memory to store such software.

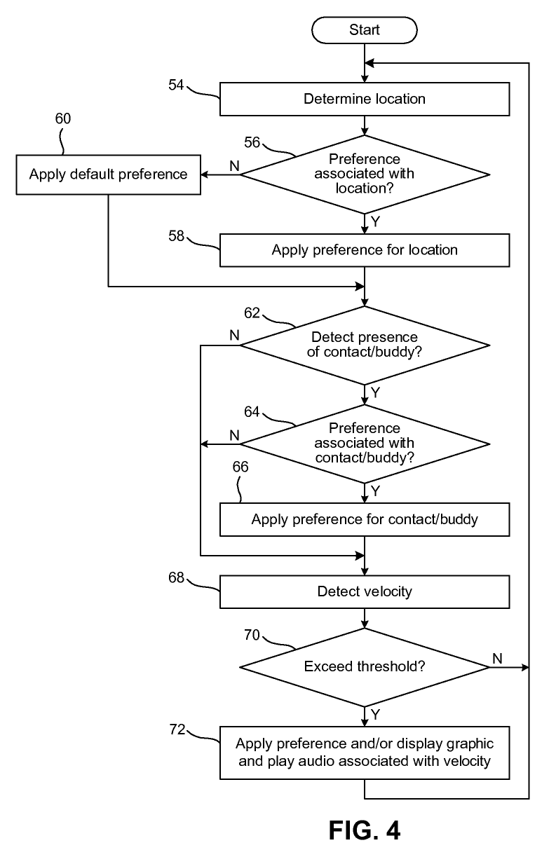

With additional reference to FIG. 4, illustrated are logical operations to implement an exemplary method of controlling the mobile telephone 10 to change user preferences based on a location of the mobile telephone 10 and/or the presence of other electronic devices with respect to the mobile telephone 10. The exemplary method may be carried out by executing an embodiment of the attribute function 12, for example. Thus, the flow chart of FIG. 4 may be thought of as depicting steps of a method carried out by the mobile telephone 10. Although FIG. 4 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

The logical flow for the attribute function 12 may begin in block 54 where a location of the mobile telephone 10 is determined. The current location of the mobile telephone 10 may be determined using any appropriate positioning technology. For instance, the location determination mechanism may include accessing an identity of a communications access point (e.g., communications tower) servicing the mobile telephone 10. In one embodiment, the communications tower may be part of a cellular network (e.g., a “cell” tower) that has an associated identifier (e.g., “cell ID”) and the identifier is communicated to the mobile telephone 10 or the server 52 as an identifier or position. Each identifier or cell ID in a particular servicing network may be assumed to be unique and, therefore, may be used to indicate relative proximity to a certain location. In one embodiment, the cell ID and any related radio parameters may be used to generate a coordinate value through a radio network service. For example, under global system mobile communications (GSM) and universal mobile telecommunications system (UMTS) protocols, the position could be estimated through a mobile originated location request (MO-LR) to the network so that the mobile telephone 10 position could be estimated using the network's knowledge of tower locations and antenna directions.

In other embodiments, location information may be determined by receipt of location data from a dedicated system, such as a global positioning system (GPS), Galileo satellite system or the like. Such data may be received via the position data receiver 44, if present as part of the mobile telephone 10. GPS coordinates may be expressed using a standard reference system (e.g., the world geodetic system or WGS). Also, assisted-GPS (or A-GPS) may be used to determine the location of the mobile telephone 10. A-GPS uses an assistance server, which may be implemented with the server 52. The assistance server processes location related data and accesses a reference network to speed location determination and transfer processing tasks from the mobile telephone 10 to the server 52. For instance, the assistance server may perform tasks to make range measurements and calculate position solutions that would otherwise be carried out by the position data receiver 44 or elsewhere in the mobile telephone 10.

Following the location determination in block 54, the logical flow may proceed to block 56 where a determination is made as to whether a user preference is associated with the identified location or multiple user preferences (e.g., a profile of user preferences) is associated with the location. The preferences or profile may be user assignable for the corresponding location. Also, a preference or profile may be configured to match a location if the mobile telephone 10 is within a specified distance from the location. Thus, correlation of a location with a preference or profile may be based on proximity of the mobile telephone 10 to the location or a determination that the mobile telephone 10 is physically at the specified position.

As used herein, a user preference is any settable value that relates to a function, operation, audible attribute, visual or displayable attribute, or similar characteristic or property of the mobile telephone 10. Exemplary preferences that may be associated with a specified location or area may include, but are not limited to, a ringtone that is played upon receipt of an incoming call, a message notification tone that is played upon receipt of an incoming message (e.g., an electronic mail message, an instant message, a text message, a multimedia message, a voicemail message), a wallpaper displayed on the display 14, a configuration or theme of a graphical user interface (GUI), an icon or set of icons that are displayed on the display 14, a ringback tone that is played while waiting for a called party to answer, ringer volume (including silencing a ring), lighting schemes, and so forth. Another exemplary preference includes the acceptance or use of a ringtone that is pushed to the mobile telephone 10 from a calling device. Another exemplary preference includes the acceptance or use of a ringback tone that is pushed to the mobile telephone 10 by a called device. Ringtones, ringback tones, message notification tones, and any other audiovisual content for playback by the mobile telephone 10 may be screened against a location-based criteria to determine if the content may be played back in the current location. For instance, genre and/or rating schemes (e.g., a rating akin to a movie, television or video game content or parental control rating) may be used to filter content that may not be acceptable in certain locations. The various preferences may be grouped into profiles for use in connection with specified locations.

By way of example, the user may configure attributes so that his or her ringtone is an upbeat song that is played back at high volume when the location corresponds to the user's home, but when the location is the user's workplace, the ringtone and volume setting may be more conservative in nature. As another example, the mobile telephone 10 may adopt a silent profile when the mobile telephone 10 is located at a movie theater, museum or performing arts venue. Furthermore, the user preferences may be configured to have a proximity relationship with the associated location. For instance, a certain wallpaper may be associated with all locations that are within a one mile radius of a specified friend's home. The mobile telephone 10 may be configured to take on different attributes by using various combinations of user preferences for a number of locations or regions, such as the user's home, the user's workplace, the user's school, a friend's home, an entertainment district near the user's home, an area associated with a specified city's limits (e.g., one GUI theme for when the mobile telephone 10 is in the city and another for when the mobile telephone 10 is outside the city), and so forth. Thus, for each location or area specified by the user, the user may also specify one or more user preferences. The associations of locations and user selected preference values may be stored in an appropriate database structure, such as a look-up table.

If a preference has been associated with the current location of the mobile telephone 10 due to either the physical presence of the mobile telephone 10 at a specified place or within a specified proximity of a specified place, a positive determination may be made in block 56. Upon a positive determination in block 56, the logical flow may proceed to block 58. In block 58, the preference or preferences associated with the current location of the mobile telephone 10 may be applied. For instance, if the preference associated with the location is a specified ringtone, then the mobile telephone may be controlled to play the specified ringtone when a call is received.

If there is no user-specified preference associated with the current location of the mobile telephone 10, a negative determination may be made in block 56. Upon a negative determination in block 56, the logical flow may proceed to block 60. In block 60, a default set of user preferences may be applied. The default preferences may be established by factory or vendor settings, or by user selection of a default profile of user preferences. In another embodiment, a previously applied location-related preference or preferences may be maintained.

Following block 58 or block 60, the logic flow may proceed to block 62 where a presence detection is made. Presence detection is typically configured to determine if an electronic device 63 (e.g., another mobile telephone as depicted in FIG. 3) that is associated with a member of a user-populated “buddy list” or with a contact list entry is physically near the mobile telephone 10. Various methods of presence detection may be employed. For example, near field communication using radio frequency (RF) transponders and readers may be used to detect other electronic devices and receive a unique identifying value from the nearby electronic devices. If a received identifying value matches a previously known value, a determination may be made that an associated buddy or contact is nearby. Other wireless interfaces, such as Bluetooth, WiFi or near field communications (NFC), may be used in a similar manner to detect the presence of known electronic devices. The identity of the detected device may be that of a device that is associated with the wireless interface, such as a unique identity of a television set or a computer that may be communicated over a corresponding short range communications link. In other instances, the identity may be the identity of a short range communication apparatus, such as a service set identifier (SSID) of a WiFi access point.

In other embodiments, the communications network 50 may host a service to inform the mobile telephone 10 of the relative proximity of one or more electronic devices belonging to persons previously identified by the user of the mobile telephone 10. In an alternative embodiment, the mobile telephone 10 may be configured to detect availability of a buddy, contact or device rather than physical presence.

If a positive determination is made in block 62, the logical flow may proceed to block 64. In block 64, a determination may be made as to whether a user preference has been associated with the contact or buddy that was detected in block 62. The preferences associated with presence of one or more buddies or contacts may be the same types of preferences associated with various locations as described above. For instance, the contact or buddy may be associated with a particular wallpaper and/or ringtone, for example. Also, ringtones, ringback tones, and any other audiovisual content may be controlled to avoid playback of content that may be embarrassing in front of a specific person.

If a positive determination is made in block 64, the logical flow may proceed to block 66 where the preference associated with the contact or buddy is applied. Additional logic may be added to detect the departure of a buddy or contact and to return the preferences of the mobile telephone 10 to the preference used before detection of the buddy or contact. In other embodiments, preferences may be assigned based on the number of detected buddies or contacts, rather than the identity of a buddy or a contact.

Following block 66 or a negative determination in either of blocks 62 or 64, the logical flow may proceed to block 68. In block 68, a velocity of the mobile telephone 10 may be detected. The detected velocity may relate to the rate of travel of the mobile telephone 10. If the mobile telephone 10 is stationary, no velocity may be detected. If the user is walking and carrying the mobile telephone 10, a relatively low velocity may be detected. If the user is traveling by car, bus, train or airplane, relatively high velocities may be detected. The velocity may be detected as a function of changes in location over time. The location detection methods described above may be used to detect a current location and that location may be compared against one or more prior locations. The distances between the locations and the time between location determinations may be used to generate a velocity value.

Following block 68, the logical flow may proceed to block 70. In block 70, a determination may be made as to whether the velocity exceeds a predetermined threshold or one of multiple predetermined thresholds. One exemplary threshold value may be set relatively high to correspond to travel by aircraft. Another exemplary threshold value may be set to correspond to travel by a land-based vehicle, such as a car. Another exemplary threshold value may be set to correspond to travel by a land-based vehicle (e.g., a car), but at a speed that exceeds most speed limits for roadways in the location of the mobile telephone 10 (e.g., a velocity value greater than the speed limit for highways in the jurisdiction in which the mobile telephone 10 is present). Another exemplary threshold value may be set to correspond to a jogging pace of the user.

If one or more of the thresholds are exceeded, a positive determination may be made in block 70 and the logical flow may proceed to block 72. In block 72, any user-selected preferences that are associated with the exceeded threshold(s) may be applied. For instance, if travel by car is detected, corresponding preferences may result in increasing ringer volume. Also, graphics may be displayed and/or audio content may be played in response to exceeding certain velocity thresholds. For instance, if it is detected that the user is traveling at a jogging pace, the mobile telephone 10 may audibly output encouragement for the user to continue exercising. Also, the mobile telephone 10 may audibly output incremental distances traveled at the jogging pace so that the user may keep track of how far he or she has run. As another example, if the user is traveling by car at a pace that exceeds the speed limit threshold, the user interface may be controlled to display an animation or graphic, such as an image of a police officer and flashing lights with text reading “slow down.” Following block 72 or a negative determination in block 70, the logical flow may return to block 54 to continue to track the location of the mobile telephone 10 and, following operation of the ensuing logical blocks, continue to monitor for the presence of a contact or buddy.

Additional parameters may be used to determine which user preferences to employ. For example, time of day and/or day of the week may be used instead of or in combination with location, presence and/or velocity to determine which user preferences to use for the mobile telephone 10. For example, if the time is during the user's regular working hours, then preferences associated with a work profile may be used or the preferences associated with the location of the user's workplace may be used. In this manner, sounds made by the mobile telephone 10 and graphics displayed by the mobile telephone 10 may be kept to professional expectations during business hours, even if the user travels outside his or her ordinary workplace. Similarly, other preferences may be used during other time segments, such as times during which the user tends to socialize, attend a class, wake up, and so forth.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A method of controlling preferences of a mobile telephone, comprising:
associating one or more user-settable preferences with a location or geographic area; and
applying the one or more preferences to operation of the mobile telephone when the mobile telephone is at the location or geographic area.

2. The method of claim 1, wherein the user-settable preference relates to a ringtone such that if a call is received when the mobile telephone is present at the location or geographic area, the mobile telephone will audibly output the ringtone.

3. The method of claim 1, wherein the user-settable preference relates to a message notification tone such that if a message is received when the mobile telephone is present at the location or geographic area, the mobile telephone will audibly output the message notification tone.

4. The method of claim 1, wherein the user-settable preference relates to a wallpaper such that when the mobile telephone is present at the location or geographic area, the mobile telephone will display the wallpaper in association with a graphical user interface.

5. The method of claim 1, wherein the user-settable preference relates to a configuration of a graphical user interface such that when the mobile telephone is present at the location or geographic area, the mobile telephone will display the configuration of the graphical user interface and function in accordance therewith.

6. The method of claim 1, wherein the user-settable preference relates to at least one of acceptable audiovisual content, acceptable ringtones, acceptable message notification tones or acceptable ringback tones, such that when the mobile telephone is present at the location or geographic area, the mobile telephone will filter at least one of audiovisual content, ringtones, message notification tones or ringback tones for acceptability before playback.

7. The method of claim 1, further comprising:
associating one or more user-settable preferences with an electronic device having a known identity;
detecting presence of the electronic device; and
applying the one or more preferences associated with the electronic device to operation of the mobile telephone.

8. The method of claim 1, further comprising:
associating one or more user-settable preferences with a segment of time; and
during the segment of time, applying the one or more preferences associated with the segment of time to operation of the mobile telephone.

9. The method of claim 1, further comprising:
associating one or more user-settable preferences with a velocity threshold;
determining a velocity of the mobile telephone; and
applying the one or more preferences associated with the velocity threshold when the velocity threshold is exceeded.

10. A method of controlling preferences of a mobile telephone, comprising:
associating one or more user-settable preferences with an electronic device having a known identity;
detecting presence of the electronic device; and
applying the one or more preferences associated with the electronic device to operation of the mobile telephone.

11. The method of claim 10, wherein the user-settable preference relates to a ringtone such that if a call is received when presence of the electronic device is detected, the mobile telephone will audibly output the ringtone.

12. The method of claim 10, wherein the user-settable preference relates to a message notification tone such that if a message is received when presence of the electronic device is detected, the mobile telephone will audibly output the message notification tone.

13. The method of claim 10, wherein the user-settable preference relates to a wallpaper such that when presence of the electronic device is detected, the mobile telephone will display the wallpaper in association with a graphical user interface.

14. The method of claim 10, wherein the user-settable preference relates to a configuration of a graphical user interface such that when presence of the electronic device is detected, the mobile telephone will display the configuration of the graphical user interface and function in accordance therewith.

15. The method of claim 10, wherein the user-settable preference relates to at least one of acceptable audiovisual content, acceptable ringtones, acceptable message notification tones or acceptable ringback tones, such that when presence of the electronic device is detected, the mobile telephone will filter at least one of audiovisual content, ringtones, message notification tones or ringback tones for acceptability before playback.

16. The method of claim 10, further comprising:
associating one or more user-settable preferences with a segment of time; and
during the segment of time, applying the one or more preferences associated with the segment of time to operation of the mobile telephone.

17. The method of claim 10, further comprising:
associating one or more user-settable preferences with a velocity threshold;
determining a velocity of the mobile telephone; and
applying the one or more preferences associated with the velocity threshold when the velocity threshold is exceeded.

18. A method of controlling preferences of a mobile telephone, comprising:
associating one or more user-settable preferences with a segment of time; and
during the segment of time, applying the one or more preferences associated with the segment of time to operation of the mobile telephone.

19. The method of claim 18, wherein the user-settable preference relates to a preference selected from a ringtone, a message notification tone, a wallpaper, a configuration of a graphical user interface and combinations thereof.

20. The method of claim 18, wherein the user-settable preference relates to at least one of acceptable audiovisual content, acceptable ringtones, acceptable message notification tones or acceptable ringback tones, such that during the segment of time, the mobile telephone will filter at least one of audiovisual content, ringtones, message notification tones or ringback tones for acceptability before playback.
